(19) United States
(12) Patent Application Publication
(10) Pub. No.: US 2017/0178817 A1
(43) Pub. Date: Jun. 22, 2017

(54) DIELECTRIC FILMS AND RELATED FILM CAPACITORS

(71) Applicant: General Electric Company, Schenectady, NY (US)

(72) Inventors: Norberto Silvi, Clifton Park, NY (US); Jeffrey S. Sullivan, Rexford, NY (US); Daniel Qi Tan, Rexford, NY (US); Kevin Warner Flanagan, Troy, NY (US)

(21) Appl. No.: 15/397,135

(22) Filed: Jan. 3, 2017

Related U.S. Application Data
(63) Continuation-in-part of application No. 14/975,942, filed on Dec. 21, 2015.

(51) Int. Cl. H01G 4/33; C08G 73/10; H01G 4/18

(52) U.S. Cl. CPC H01G 4/33; H01G 4/18; C08G 73/1071

(57) ABSTRACT

A dielectric film that includes a sheet fabricated from a dielectric material. The sheet has a thickness of less than about 5 microns, wherein the dielectric material includes an amorphous polymer, and wherein the dielectric material is substantially free of a solvent.

### CROSS-REFERENCE TO RELATED APPLICATIONS

This application is a continuation-in-part and claims priority to U.S. patent application Ser. No. 14/975,942, filed Dec. 21, 2015 for “METHODS FOR FORMING DIELECTRIC FILMS AND RELATED FILM CAPACITORS”, which is incorporated by reference herein in its entirety.

### BACKGROUND

The disclosure relates generally to methods for forming dielectric films. More particularly, the disclosure relates to methods for forming bi-axially stretched dielectric films of amorphous polymers.

Over the last decade, significant improvements in capacitor reliability have been achieved through a combination of advanced manufacturing techniques and new materials. Enhanced performance has been obtained particularly in so-called film capacitors, such as metallized film capacitors.

Compared to other types of film capacitors, metallized film capacitors provide certain advantages such as size, simplicity, and cost of manufacturing, and hence have been widely used in the power electronics industry. Typically, metallized film capacitors include two metal electrodes separated by a polymer film. An example of the commonly used polymer film includes polypropylene. However, polypropylene-based film capacitors sometimes have challenges in high-temperature industrial applications because of polypropylene's inherent temperature limitations. Amorphous polymers, for example polyetherimide (PEI) resins have been recently considered as potential dielectric materials for the film capacitors because these polymers exhibit higher glass transition temperatures than conventionally used polymers (such as, polypropylene). Polymer films formed using these amorphous polymers have one or more of the desired characteristics for a film capacitor such as high temperature stability, desired heat resistance, desired voltage resistance, high dielectric breakdown voltage, high dielectric constant, and low dielectric loss.

Moreover, thinner polymer films (for example, with thickness less than 5 microns) are desirable to reduce both the cost and volume of the film capacitors made from such films. However, conventional methods for forming thin polymer films, for example, solvent-based methods have several issues including the presence of residual solvent in the film, shrinkage, poor thermal stability, and dielectric properties. Melt-based methods include blown film extrusion and stretching. Stretching may improve some physical properties of the polymer films, for example tensile strength and modulus of elasticity. However, forming thin films of amorphous polymers is sometimes challenging because of the lack of appropriate methods and processing conditions to achieve the desired thickness (less than 5 microns), uniformity and quality. Typically, melt-extruded films of amorphous polymers are stretched along the longitudinal direction to form uni-axially stretched dielectric films having a thickness greater than 5 microns. However, further stretching of the uni-axially stretched dielectric film to reduce the thickness, for example below 5 microns, sometimes results in one or more quality issues such as pin-holes, thickness non-uniformity, tin-canning instabilities, film breakage and wrinkles.

Thus, there is a need for improved methods for forming thin dielectric films of amorphous polymers.

### BRIEF DESCRIPTION

In one aspect, a dielectric film is provided. The dielectric film includes a sheet fabricated from a dielectric material. The sheet has a thickness of less than about 5 microns, wherein the dielectric material includes an amorphous polymer, and wherein the dielectric material is substantially free of a solvent.

In another aspect, a film capacitor is provided. The film capacitor includes at least one layer of metallic material and a dielectric film coupled to the at least one layer of metallic material. The dielectric film includes a sheet fabricated from a dielectric material. The sheet has a thickness of less than about 5 microns, wherein the dielectric material includes an amorphous polymer, and wherein the dielectric material is substantially free of a solvent.

### DRAWINGS

These and other features, aspects, and advantages of the present disclosure will become better understood when the following detailed description is read with reference to the accompanying drawings in which like characters represent like parts throughout the drawings, wherein:

FIG. 1 schematically shows a top view of an exemplary system for stretching a sheet of dielectric material using the methods shown in FIGS. 3-6;

FIG. 2 illustrates an exemplary film capacitor that may be manufactured from the stretched sheet of dielectric material formed from the system shown in FIG. 1;

FIG. 3 is a flow chart of a first method of forming thin dielectric films;

FIG. 4 is a flow chart of a second method of forming thin dielectric films;

FIG. 5 is a flow chart of a third method of forming thin dielectric films; and

FIG. 6 is a flow chart of a fourth method of forming thin dielectric films.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Similarly, “free” may be used in combination with a term, and may include an insubstantial number, or trace amounts, while still being considered free of the modified term. Here and throughout the specification and claims, range limitations may be combined and/or interchanged. Such ranges are identified and include all the sub-ranges contained therein unless context or language indicates otherwise.

As used herein, the term “film” refers to a film formed using a melt-based method, in a continuous or discontinuous manner. In certain embodiments, the film is formed in a continuous manner. Further, the term “film” does not necessarily mean a uniform thickness of the material, and may have a uniform or variable thickness.

Stretched dielectric films, for example uni-axially stretched dielectric films and bi-axially stretched dielectric films, refer to oriented dielectric films prepared by stretching the sheet of dielectric material in at least one planar direction near a deformation temperature range of the substantially amorphous polymer. The deformation temperature range refers to a temperature range in which molecular orientation of the polymer is affected. Below the deformation temperature range, a film formed by the sheet of dielectric material may tend to break; and above the deformation temperature range, the film may elongate without orienting. The deformation temperature range for a given amorphous polymer can be readily determined by one skilled in the art. In some embodiments, the deformation temperature range is less than a melting or a decomposition temperature of the amorphous polymer.

Embodiments of the present specification address the noted shortcomings in the art. Some embodiments are directed to a method for forming a bi-axially stretched dielectric film. The method includes stretching a sheet of dielectric material along a transverse direction to form a bi-axially stretched dielectric film having a thickness less than 5 microns. The sheet of dielectric material is heated using infrared radiation during at least a duration of the stretching step. The dielectric material includes a substantially amorphous polymer having a glass transition temperature greater than 140 degrees Celsius (° C.).

Therefore, embodiments of the specification advantageously provide for methods of forming thin (less than 5 microns thick) bi-axially stretched dielectric films from dielectric materials including substantially amorphous polymers. As used herein, the term “substantially amorphous polymer” refers to a polymer that is substantially free of a crystalline phase. In some embodiments, the substantially amorphous polymer has a small quantity of crystalline phase, for example less than 5 weight percent. In some embodiments, the amorphous polymer has a crystalline phase in a range from about 0.1 weight percent to about 2 weight percent. The amorphous polymer has a glass transition temperature greater than 140 degrees Celsius. In some embodiments, the amorphous polymer has a glass transition temperature in a range from about 150 degrees Celsius to about 250 degrees Celsius. These amorphous polymers having high glass transition temperature may be desirable to achieve the desired characteristics for a film capacitor such as high temperature stability and desired heat resistance. Suitable examples of amorphous polymers include, but are not limited to, a polycarbonate, a polysulfone, a polyethersulfone, a polyamide-imide, a polyetherimide, and combinations thereof.

In certain embodiments, the dielectric material includes a polyetherimide. Non-limiting examples of suitable polyetherimides include ULTEM® 1000 resin series, ULTEM® 5000 resin series, and ULTEM® CRS 5000 resin series. In certain embodiments, the dielectric material consists essentially of a polyetherimide. The term “consists essentially of” as used herein means that the dielectric material primarily includes a polyetherimide and does not include additional materials, such as, metal or semiconductor particles that may alter the properties of the dielectric material. In some embodiments, the dielectric material includes a small quantity (less than about 100 parts per million (ppm)) of metal contaminants by weight of the dielectric material. More specifically, in one embodiment, the dielectric material has a metal content of less than about 50 ppm by weight of the dielectric material.

In some embodiments, the dielectric material further includes one or more fillers to improve the material properties, such as, dielectric constant and thermal conductivity. The fillers include, but are not limited to, an organic material, an inorganic material or combinations thereof. The filler has a primary dimension of the order of nanometers, for example from about 0.1 nanometer to about 1000 nanometers. Suitable examples of the fillers include, but are not limited to, alumina, silica, organic titanates, metal titanates such as barium titanate, or combinations thereof. In one embodiment, the fillers are present in a small amount (less than 30 volume percent, based on a total amount of the dielectric material), and uniformly dispersed into the amorphous polymer. In one embodiment, the desired filler is added to the amorphous polymer while the amorphous polymer is being synthesized. Alternatively, the desired filler is added in a subsequent step by mixing.

As used herein, “sheet of dielectric material” refers to a material obtained directly after a melt process, or alternately to a material that has undergone one or more processing steps (for example, stretching in a longitudinal direction) after the melt process.

In some embodiments, the method further includes a step of providing the sheet of dielectric material. The dielectric material is procured or formed by melt-based methods. The sheet of dielectric material formed by melt-based methods generally has good thermal stability and dielectric properties, and less shrinkage due to the absence of residual solvent as compared to that of a sheet of dielectric material processed or formed by solvent-based methods. In some embodiments, the dielectric material is substantially free of a solvent. As used herein, the term “substantially free of a solvent” refers to a dielectric material that contains no, or less than 1 weight percent, solvent. More specifically, in one embodiment, the dielectric material has a solvent content of less than about 30 ppm by weight of the dielectric material.

In addition, in some embodiments, the dielectric material is substantially free of a slip agent such as, but not limited to, fluorinated slip agents (e.g., fluorinated polyethylene), sodium stearate, and calcium stearate. As used herein, the term “substantially free of a slip agent” refers to a dielectric material that contains no, or less than 1 weight percent, of a slip agent. Slip agents provide lubricity when layers of a film are wound upon each other and, in the instant case, a slip agent is not used when stretching the sheet of dielectric material in the longitudinal and transverse directions, as will be described in more detail below.

In some embodiments, the dielectric material is in the form of a melt, a web, a sheet, or a film. Non-limiting examples of melt-based methods for forming the dielectric material include melt-extrusion, such as blown film extrusion or melt-casting.

In some embodiments, the sheet of dielectric material is in the form of a melt-extruded film. The term “melt-extruded film” as used herein refers to an as-formed film that has not undergone any substantial stretching in one or both of longitudinal and transverse directions. In some embodiments, the melt-extruded film has a thickness in a range of from about 100 microns to about 500 microns. In certain embodiments, the melt-extruded film has a thickness in a range of from about 250 microns to about 350 microns.

In some other embodiments, the sheet of dielectric material is in the form of a uni-axially stretched film. As used herein, the term “uni-axially stretched film” refers to a film that is formed by stretching a sheet of dielectric material along a single planar direction, that is, in a longitudinal direction of the film. The longitudinal direction of the film refers to a direction extending along a length of the film. The longitudinal direction may also refer to a machine direction, and stretching the sheet of dielectric material along the longitudinal direction may be referred to as machine direction orientation (MDO) stretching. In some embodiments, the melt-extruded film is stretched along the longitudinal direction (i.e., using MDO stretching) to form the uni-axially stretched film, before the step of stretching the sheet of dielectric material to form the bi-axially stretched film. In some other embodiments, the uni-axially stretched film is procured as a pre-formed film from a suitable source. The uni-axially stretched film has a thickness in a range from about 5 microns to about 30 microns. In some embodiments, the uni-axially stretched film has a thickness in a range from about 8 microns to about 25 microns, and in certain embodiments, from about 10 microns to about 20 microns.

As noted, the sheet of dielectric material is stretched along the transverse direction to form a bi-axially stretched dielectric film having a thickness less than 5 microns. The term “bi-axially stretched dielectric film”, as used herein, refers to a dielectric film that is formed from a sheet of dielectric material that has been stretched along two planar directions (i.e., x-y directions), that is the longitudinal direction and a transverse direction. A transverse direction of the dielectric film refers to a direction perpendicular to the longitudinal direction of the dielectric film in the plane of the dielectric film. Stretching a sheet of dielectric material in the transverse direction may also be referred to as transverse direction orientation (TDO) stretching.

In embodiments wherein the dielectric material is in the form of the melt-extruded film, the method further includes stretching the melt-extruded film along the longitudinal direction. In such instances, the melt-extruded film is stretched along the longitudinal direction either prior to the step of stretching along the transverse direction or simultaneously with the step of stretching along the transverse direction. In embodiments wherein the sheet of dielectric material is in the form of the uni-axially stretched dielectric film, the method includes stretching the uni-axially stretched dielectric film along the transverse direction to form the bi-axially stretched dielectric film.

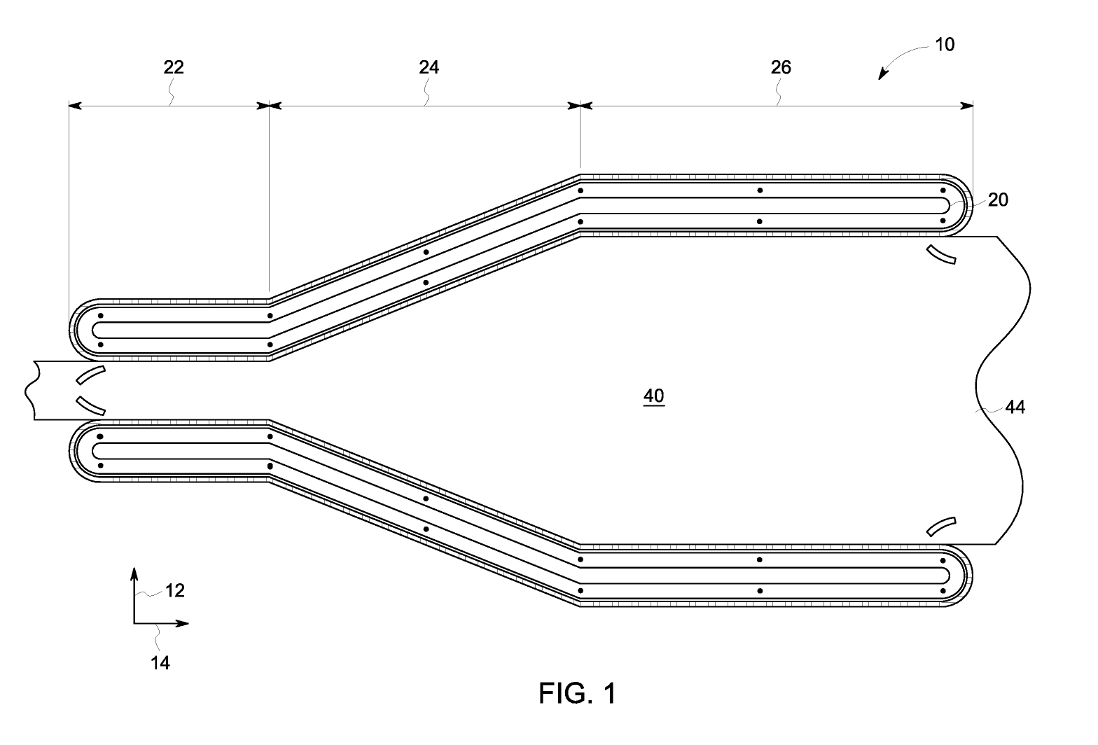

FIG. 1 shows a schematic top view of a system 10, for example an infra-red transverse direction orientation (IRTDO) system. System 10 includes a tenter frame 20. The dielectric material to be stretched in system 10 is obtained from any appropriate source, such as a supply roll or directly from a melt-extrusion apparatus. As shown in FIG. 1, a sheet 40 of dielectric material is supplied to tenter frame 20 in the form of a continuous web (as produced from a typical film production line). The terms “web” and “sheet” may be used interchangeably in the specification. Tenter frame 20 holds sheet 40, for example with the help of tenter clips. Tenter frame 20 is configured to stretch sheet 40 at least along a transverse direction (shown by arrow 12). In some embodiments, tenter frame 20 is also configured to stretch sheet 40 along a longitudinal direction (shown by arrow 14).

System 10 further includes a plurality of infrared (IR) heaters. Infrared heaters (not shown) are employed in various locations of system 10 to heat sheet 40 at least prior to the stretching step, during the stretching step, or after the stretching step. In some embodiments, the temperature of sheet 40 is maintained within a predetermined temperature range suitable for the dielectric material used. Various portions of sheet 40 (such as, a central portion or an edge portion) are exposed to different temperatures to establish and maintain the desirable temperature differentials. In some embodiments, sheet 40 is exposed to a temperature from about 260 degrees Celsius to about 540 degrees Celsius in the various portions. The temperature of sheet 40 is in a range from about 230 degrees Celsius to about 290 degrees Celsius. Further, in some embodiments, various cooling and pre-treating means are employed in system 10 for cooling and treating sheet 40 either during or prior to the stretching step.

As illustrated in FIG. 1, in some embodiments, tenter frame 20 includes at least three sections, for example a first section 22, a second section 24 and a third section 26. Sheet 40 is first supplied into first section 22. In first section 22, sheet 40 is exposed to a predetermined temperature for a particular duration, prior to the stretching step. In some embodiments, sheet 40 is exposed to a temperature in a range from about 420 degrees Celsius to about 540 degrees Celsius. The duration for exposing sheet 40 to a temperature in each of the three sections depends on various processing parameters such as drawing rate, tenter speed, and the lengths of the respective sections.

With continued reference to FIG. 1, heated sheet 40 is further supplied to second section 24 where sheet 40 is stretched at least along the transverse direction to form a bi-axially stretched dielectric film having a thickness of less than about 5 microns. In embodiments where sheet 40 is in the form of a uni-axially stretched dielectric film, the method includes stretching the uni-axially stretched dielectric film along the transverse direction. In these embodiments, system 10 performs the TDO stretching in second section 24.

In embodiments wherein sheet 40 is in the form of “as-formed” melt (for example, a melt-extruded film), the method includes stretching sheet 40 along the longitudinal direction and the transverse direction simultaneously. In these embodiments, tenter frame 20 is further configured to perform the MDO stretching in second section 24. In these instances, sheet 40 is stretched along the longitudinal direction and the transverse direction simultaneously using tenter frame 20 for MDO stretching and TDO stretching. In embodiments where the method includes stretching the sheet of dielectric material along the longitudinal direction and the transverse direction sequentially, tenter frame 20 is configured to perform the MDO stretching of sheet 40 before performing the TDO stretching. In some embodiments, the MDO stretching of sheet 40 is performed before supplying the dielectric material to second section 24 of system 10 so that a uni-axially stretched dielectric film is supplied to second section 24. In some embodiments, the MDO stretching is performed outside system 10 such that the uni-axially stretched dielectric film is supplied to system 10 via first section 22.

After sheet 40 has been bi-axially stretched in second section 24, the dielectric material is moved into third section 26 where the dielectric material is heat set within a temperature range appropriate for the amorphous polymer used. As an example, for a polyetherimide, the dielectric material is exposed to a temperature in a range from about 310 degrees Celsius to 490 degrees Celsius in third section 26 during the heat setting step. After third section 26, a bi-axially stretched dielectric film 44 is received from system 10. In some embodiments, the thickness of bi-axially stretched dielectric film 44 is lower at a central portion when compared to the edge portions. The thicker edge portions are slit from bi-axially stretched dielectric film 44 prior to using the film or winding the film into a roll.

The thickness and uniformity of bi-axially stretched dielectric film 44 is controlled in part through various process parameters such as temperature, stretch ratio, drawing rate of the sheet of dielectric material during the stretching step. The sheet of dielectric material is stretched at least 1.5 times to its original dimension in each direction (i.e., along the longitudinal direction and the transverse direction) to form bi-axially stretched dielectric film 44. In some embodiments, the method includes stretching the sheet of dielectric material using a stretch ratio in a range from about 1.5 to about 6 at least along the transverse direction. In certain embodiments, the method includes stretching the sheet of dielectric material using a stretch ratio in a range from about 2 to about 5 at least along the transverse direction. The stretch ratio along the transverse direction is calculated by dividing the width of bi-axially stretched dielectric film 44 exiting system 10 by the width of sheet 40 entering to system 10. For instance, if the width of bi-axially stretched dielectric film 44 at the exit of system 10 is 20 inches and the width of sheet 40 at an entrance of system 10 is 10 inches, then the stretch ratio is equal to 2.

In second section 24, during the stretching step, the dielectric material is exposed to a temperature in a range from about 310 degrees Celsius to about 490 degrees Celsius for a particular duration of the stretching step. The dielectric material is exposed to the temperature continuously or periodically during the stretching step. Further, the dielectric material is exposed to different temperatures at different portions (such as the central portion and the edge portions) such that a temperature of the sheet of dielectric material may desirably vary from the central portion to the edge portions. In some embodiments, the edge portions are exposed to a lower temperature (e.g., from about 310 degrees Celsius to about 380 degrees Celsius) than that of the central portion. As discussed, the dielectric material is heated using IR radiation. The temperature of the dielectric material is desirably maintained or varied using IR heaters at various desirable locations inside system 10.

The edge and central portions of sheet 40 of dielectric material are heated to the appropriate temperatures for sufficiently stretching sheet 40 without tearing from the tenter clips. If the temperature at the edge portions is low, sheet 40 may not stretch at the edge portions and the thickness may be larger at the edge portions compared to the central portion of sheet 40. If the temperature at the edge portions is high, the dielectric material may be soft at the edge portions, and sheet 40 may either tear or break or detach from the tenter clips. In some embodiments, the temperature of the IR heaters is varied in the direction across the longitudinal direction of sheet 40. In some instances, the edge portions gripped in the tenter clips are protected from IR heat using ceramic heat deflectors. As such, premature softening of the dielectric material in these edge portions is restricted.

The term, “drawing speed”, as used herein, refers to a speed by which sheet 40 is moved in the longitudinal direction or drawn out of the system. In system 10, the drawing speed of sheet 40 is controlled by a tenter speed. In some embodiments, the method includes stretching sheet 40 using a drawing speed in a range from about 0.3 meters/minute (m/min) to about 15.24 m/min. In certain embodiments, the drawing speed is in a range from about 3.05 m/min to about 9.1 m/min.

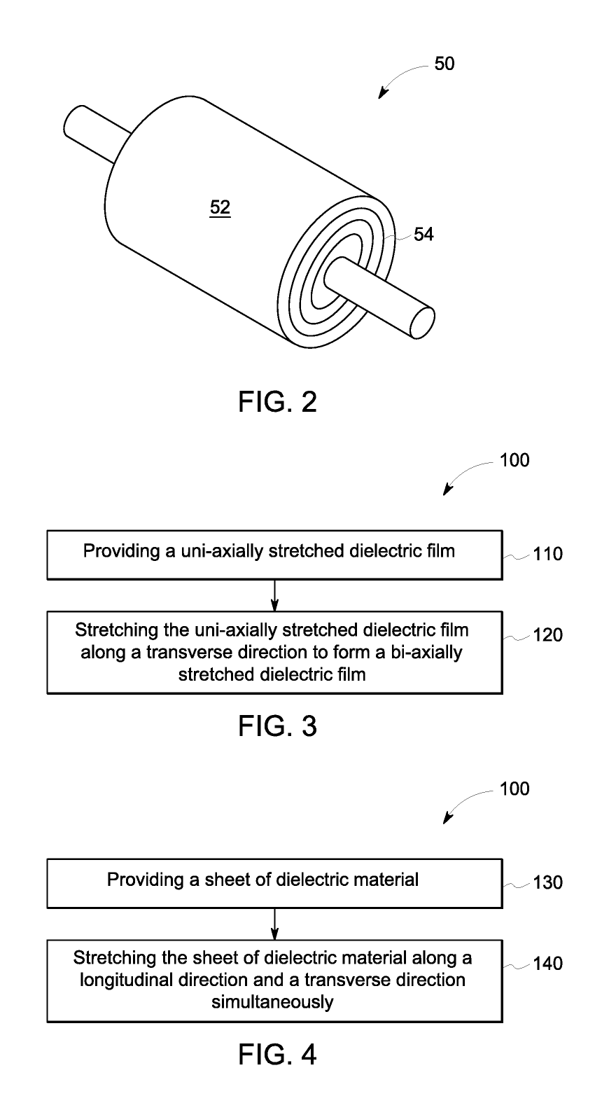

Some embodiments present a film capacitor that includes a bi-axially stretched dielectric film formed by the method as discussed below. The film capacitor may be used, for example in inverters for hybrid electric vehicles, engine starters for avionics, pulsed-power applications, and oil-and-gas electronic devices. FIG. 2 shows a schematic of a film capacitor 50. Film capacitor 50 includes a dielectric film 52 and a layer 54 of metallic material wound in a cylindrical configuration of the capacitor. More specifically, the bi-axially stretched dielectric film is metallized on one side (that is, on one surface) or on both sides to form the metallized dielectric layer. Layer 54 of metallic material includes a metal such as, but not limited to, aluminum, copper, or zinc, which is vacuum deposited on the bi-axially stretched dielectric film. Layer 54 of metallic material is usually thin, and has a thickness defined within a range between about 200 angstroms and about 500 angstroms. In an alternative embodiment, dielectric film 52 is not metallized, and rather layer 54 of metallic material (i.e., an electrode) is formed separately from and coupled to one or both sides of dielectric film 52.

FIGS. 3-5 illustrate flow charts of a method 100 for forming the bi-axially stretched dielectric film of thickness less than 5 microns, according to some embodiments.

As shown in FIG. 3, in some embodiments, the method 100 includes step 110 of providing a sheet of dielectric material in the form of a uni-axially stretched dielectric film. The uni-axially stretched dielectric film is provided by procuring a pre-formed uni-axially stretched dielectric film or stretching the sheet of dielectric material along the longitudinal direction by using a suitable MDO stretching technique, for example differential speed rolls. The method further includes step 120 of stretching the uni-axially stretched dielectric film along the transverse direction to form the bi-axially stretched dielectric film. The details of the stretching step are discussed hereinbelow.

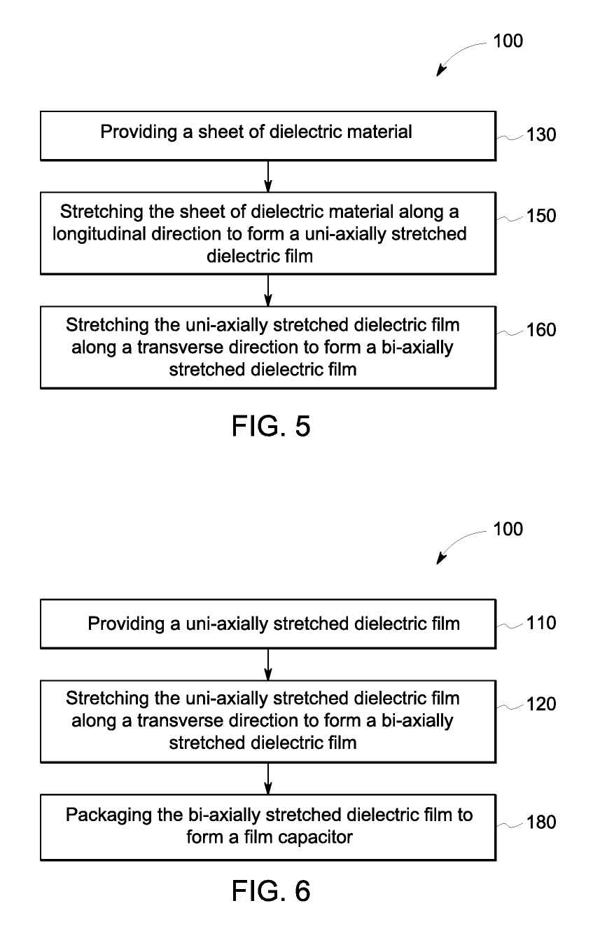

As shown in FIGS. 4 and 5, in some embodiments, the method includes step 130 of providing a sheet of dielectric material in the form of a melt, for example a melt-extruded film. The sheet of dielectric material is stretched along the longitudinal direction and the transverse direction simultaneously or sequentially, as illustrated in FIGS. 4 and 5. FIG. 4 illustrates method 100 that includes step 140 of simultaneously stretching the sheet of dielectric material along the longitudinal direction and the transverse direction. In FIG. 5, method 100 includes step 150 of stretching the sheet of dielectric material along the longitudinal direction to form the uni-axially stretched dielectric film before step 160 of stretching the uni-axially stretched dielectric film along the transverse direction to form the bi-axially stretched dielectric film.

As mentioned earlier, the dielectric material is heated using infrared radiation during at least a duration of the stretching step. In some embodiments, the stretching step is carried out in a system configured to perform at least TDO stretching in the presence of infrared (IR) radiation during at least a duration of the stretching step. In some embodiments, the system is further configured to perform MDO stretching. Such a system is described in detail below with reference to FIG. 1.

In some embodiments, as shown in FIG. 6, method 100 further includes step 180 of packaging the bi-axially stretched dielectric film 44 to form a film capacitor 50 (FIG. 2). Packaging step 180 includes metallizing bi-axially stretched dielectric film 44 to form a metallized dielectric film and winding the metallized dielectric film in a suitable configuration. The bi-axially stretched dielectric film is metallized at one side or both sides of the film.

Some embodiments provide a bi-axially stretched dielectric film formed by the method as discussed hereinabove. The bi-axially stretched dielectric film has a thickness less than about 5 microns. In some embodiments, the bi-axially stretched dielectric film has a thickness in a range from about 0.1 micron to about 4 microns. In certain embodiments, the thickness of the bi-axially stretched dielectric film is in a range from about 0.5 micron to about 3 microns. Moreover, the bi-axially stretched dielectric film has a substantially uniform thickness. As used herein, the term “substantially uniform thickness” means that the thickness variation across the bi-axially stretched dielectric film is less than 10 percent. In addition, the bi-axially stretched dielectric film is substantially free of surface defects such as, but not limited to, pin-holes, tin-canning, wrinkling, and combinations thereof. For example, each side of the bi-axially stretched dielectric film has a surface area. As used herein, the term “substantially free of surface defects” means at least 80 percent of the surface area is free of the surface defects. Quantified in another way, the bi-axially stretched dielectric film has an average surface roughness of less than about 3 percent.

In one embodiment, the bi-axially stretched dielectric film has a dielectric breakdown strength of at least about 400 volts/micron. In certain embodiments, the bi-axially stretched dielectric film has a dielectric breakdown strength in a range from about 400 volts/micron to about 1000 volts/micron. In addition, the bi-axially stretched dielectric film has a dielectric constant of at least about 2.7 at 1 kilohertz and room temperature, and a dissipation factor of less than about 1 percent at 1 kilohertz and room temperature.

Embodiments of the present disclosure provide methods for producing dielectric films of thickness less than 5 microns from an amorphous polymer. According to some embodiments, these thin dielectric films have the desired thickness uniformity, desired dielectric properties, a high breakdown strength (at least 450 V/micron), and are able to continuously operate at elevated temperatures of 120 degrees Celsius and higher. Furthermore, these films have low levels of impurities and no surface imperfections because these films are produced entirely from a melt (no use of a solvent). The combination of small film thickness (less than 5 microns) with high dielectric constant and high dielectric strength may be beneficial in the manufacturing of high energy density film capacitors that can work at elevated temperatures as compared to state of the art polypropylene capacitors.

### EXAMPLES

### Comparative Example

A polyetherimide (PEI) film (Ultem™) of thickness 13 microns was processed by sequential stretching in MDO and TDO in an oven using convection air for heating. The PEI film had periodic surface instabilities of the tin-canning type. An average dielectric breakdown strength of the PEI film was 450 V/micron (one standard deviation of 20 measurements equal to 23 V/micron). During the process, the MDO stretching was run at roll temperatures between 204.4 degrees Celsius and 240.6 degrees Celsius, at a drawing speed between 3.05 m/min and 4.6 m/min, and a cooling temperature at the end of the process equal to 65.6 degrees Celsius. After completing the MDO stretching, the TDO stretching of the PEI film was run at oven temperatures between 223.9 degrees Celsius and 235 degrees Celsius, at a drawing speed of 4.6 m/min, and a stretch ratio of between 1.1 and 1.45. A bi-axially stretched PEI film of thickness about 8 microns was attained while maintaining the desired performance characteristics (e.g., no wrinkles and desired dielectric properties). An average dielectric breakdown strength of the bi-axially stretched PEI film of about 8 microns was 451 V/micron (one standard deviation of 20 measurements equal to 40 V/micron). It was observed that the processing conditions (that is, convection air heating) were not able to provide a required environment to produce a film of thickness less than 5 microns. It was concluded that the convection air used for heating inside the oven did not allow the PEI film to remain attached to the clips of a conveying mechanism used to move the film inside the oven. Furthermore, the oven heaters had insufficient heating capability to heat up the PEI film above the polymer's glass transition temperature.

### Example 1

A uni-axially stretched polyetherimide (PEI) film of nominal thickness 6 microns (Ultem™) was provided. The PEI film was about 0.49 meters wide and had surface imperfections (e.g., surface instabilities of the tin-canning type). These surface instabilities might have prevented this roll of PEI film from being metallized to finally use the metallized PEI film to form film capacitors.

To carry out TDO stretching of the PEI film, a web roll of the PEI film was transported to an entrance of an infra-red transverse direction orientation (IRTDO) system by rollers. At the entrance, the edges of the PEI film were gripped by the tenter clips of a tenter frame. The PEI film entering the tenter clips was at about room temperature. After gripping the PEI film, the tenter clips were moved in relatively straight parallel rails of tenter frame into a first section 22 (referring to FIG. 1) where the temperature of the PEI film was increased to a deformation temperature of PEI, with the help of oven's IR heaters being kept at temperatures between 454.4 degrees Celsius and 482.2 degrees Celsius. The IR heaters were arranged beyond the rails of the tenter clips to provide uniform heat flux across the width of the PEI film. After first section 22, the rails of the tenter frame diverged and opposed pairs of clips were accelerated to separate from adjacent pairs to thereby stretch the heated PEI film in the transverse direction in second section 24 of the IRTDO system. IR heaters were used inside the IRTDO system to maintain the desired temperature of the PEI film at various locations. The separation of the rails of the tenter frame changed from about 0.43 m at the entrance of second section 24 to about 0.65 m at the exit of the system. Therefore, the PEI film was stretched about 1.5 times its original width, and transformed into a bi-axially stretched PEI film that was about 3 microns to about 4 microns thick at the exit of the IRTDO system. During the TDO stretching process, a tenter speed was about 1.52 m/min. The temperature of the IR heaters in second section 24 was kept higher than 398.9 degrees Celsius.

After second section 24, in which the rails of tenter frame diverged, these rails became parallel again in third and final section 26. In third section 26, the bi-axially stretched PEI film was heat set by exposing the film to temperatures between 315.6 degrees Celsius and 371.1 degrees Celsius using IR heaters. The resulting bi-axially stretched PEI film was between 2.5 and 3.5 microns thick when measurements were taken at the central portion of the web. The temperature of the bi-axially stretched PEI film at the exit of the IRTDO system was measured equal to about 276.7 degrees Celsius. This temperature was higher than that of the bi-axially stretched PEI film of the Comparative Example 1.

Twelve measurements taken one inch apart at the central portion of the bi-axially stretched film showed an average film thickness equal to 3.06 microns with a standard deviation equal to 0.22 micron. Similar measurements taken one meter away from the previous location showed an average film thickness equal to 3.00 microns with one standard deviation equal to 0.43 micron. These consistent results suggested that the process was able to produce bi-axially stretched films containing no wrinkles with a relatively uniform thickness at the central portion of the film.

Twenty measurements of the original wrinkled 6 micron thick PEI film showed an average film thickness of 6.23 microns with one standard deviation equal to 0.03 micron, and an average dielectric breakdown strength equal to 520 V/micron with a standard deviation equal to 37 V/micron. Twenty measurements of the resulting bi-axially stretched PEI film (no wrinkles) produced by the above process showed an average film thickness of 3.16 microns with a standard deviation equal to 0.26 micron, and an average dielectric breakdown strength equal to 479 V/micron with a standard deviation equal to 45 V/micron. The lower average breakdown strength of the thinner bi-axially stretched PEI film compared to the original wrinkled 6 micron thick PEI film was due to one breakdown strength value measured 333 V/micron at one spot, most of other values of breakdown strength were as high as 535 and 563 V/micron at other portions of the measured area of the film. These values of thickness and breakdown strength were measured on a circular sample of approximate 2 inches in diameter taken from the central portion of the web. The thickness measurements were made using the Filmetrics technique, and the breakdown strength measurements were made using ASTM ball-plane sample fixture along with a Slaughter AC/DC Hipot tester with power supply. This resulting 3.2 microns bi-axially stretched PEI film of web length 167.6 m was produced with no film breakage or processing problems, and collected on a winder of the machine. It was observed that the resulting 3.2 microns bi-axially stretched PEI film produced was free of surface imperfections and had comparable breakdown strength compared to the original wrinkled 6 micron thick PEI film.

### Examples 2-7

Two polyetherimide (PEI) films (Ultem™) were provided. These films were 6 microns and 7 microns thick, and were made by stretching an extruded polymer melt uni-axially in the longitudinal direction. These PEI films had surface imperfections (e.g., surface instabilities of tin-canning type). Details of the wrinkled PEI films and the method used to process them, for example web-roll lengths, widths, thicknesses, unwind tension are provided in Table 1. The PEI films were processed using the same method as described above in Example 1 to form bi-axially stretched PEI films. Similar measurement processes were performed for measuring average thicknesses and breakdown strengths of bi-axially stretched PEI films as discussed in Example 1.

Table 1 shows the processing conditions and parameters (e.g., IR heaters' temperatures, tenter speeds, rail separations, stretch ratios, web rewind tensions, web exit widths, web exit thicknesses) used while processing the PEI films in Examples 2-7. Table 1 further shows average thicknesses and average breakdown strengths measured at two different regions (region 1 and region 2) of resulting bi-axially stretched PEI films of Examples 2-7. The resulting bi-axially stretched PEI films of examples 2-4 had average thicknesses between about 2 microns and 4 microns and average breakdown strengths higher than 400 V/micron. The conditions used in Example 5 produced a bi-axially stretched PEI film having an average thickness of about 4 microns and a breakdown strength higher than 440 V/micron. A bi-axially stretched PEI film produced in Example 7 showed an average thickness below 2 microns with a relatively small standard deviation in region 1.

TABLE 1

| | | Example | | | | | |
|---|---|---|---|---|---|---|---|
| | | Example | Example | Example | Example | Example | Example |
| parameters | | 2 | 3 | 4 | 5 | 6 | 7 |
| Web-roll width | | 0.48 | 0.48 | 0.48 | 0.48 | 0.48 | 0.48 |
| (meters) | | | | | | | |
| Web-roll length | | 91 | 85 | 421 | 1323 | 15 | 37 |
| (meters) | | | | | | | |
| Web thickness | | 6 | 6 | 6 | 7 | 7 | 7 |
| (microns) | | | | | | | |
| Roll unwind | | 30 | 30 | 30 | 30 | 20 | 20 |
| tension (%) | | | | | | | |
| Rail separation # | | 0.42 | 0.42 | 0.42 | 0.42 | 0.42 | 0.38 |
| 1 (meters) | | | | | | | |
| Rail separation # | | 0.65 | 0.65 | 0.65 | 0.65 | 0.89 | 0.89 |
| 2 (meters) | | | | | | | |
| Stretch ratio | | 1.55 | 1.55 | 1.55 | 1.55 | 2.12 | 2.34 |
| Tenter speed | | 1.49 | 3.05 | 3.05 | 6.1 | 3.05 | 3.05 |
| (drawing speed) | | | | | | | |
| (m/minute) | | | | | | | |
| Web Rewind | | 24 | 25 | 24 | 37 | 30 | 30 |
| tension (%) | | | | | | | |
| IR heaters set | | 850-900 | 850-900 | 850-900 | 900 | 875-900 | 875-900 |
| temperature (° F.) | | | | | | | |
| in the first section | | | | | | | |
| IR heaters set | | 600 | 600 | 600 | 600 | 600 | 600 |
| Temperature (° F.) | | | | | | | |
| in the third | | | | | | | |
| section | | | | | | | |
| Web exit width | | 0.66 | 0.66 | 0.66 | 0.66 | 0.97 | 0.97 |
| (m) | | | | | | | |
| Web exit trimmed | | 0.29 | 0.29 | 0.5 | 0.5 | 0.64 | 0.59 |
| width (m) | | | | | | | |
| Web exit | | 3-4 | 3-4 | 3-4 | 4-5 | 2-3 | 2-3 |
| thickness | | | | | | | |
| (microns) | | | | | | | |
| Web thickness | Region 1 | | 3.95/0.22 | 3.93/0.31 | 4.41/0.21 | | 1.77/0.16 |
| (microns) | | | | | | | |
| (Average/standard | Region 2 | | 2.15/0.17 | 2.39/0.23 | 3.29/0.31 | | 3.09/0.08 |
| deviation) | | | | | | | |
| Strength | Region 1 | | 436/89 | 465/68 | 464/73 | | 357/182 |
| (V/micron) | | | | | | | |
| (Average/ | Region 2 | | 441/105 | 422/90 | 448/101 | | 457/97 |
| standard deviation) | | | | | | | |

The embodiments described herein relate to bi-axially stretched polymeric thin films fabricated from amorphous material, having a thickness of less than about 5 microns, and that are electronics quality. More specifically, the films are formed in a biaxial stretching process that facilitates forming the films with a uniform thickness, having substantially no wrinkles and impurities, and having a high dielectric breakdown strength. In addition, no solvent is used to form the thin films described herein, such that properties of the films such as, shrinkage, thermal stability, and dielectric properties are not affected.

An exemplary technical effect of the apparatus and method described herein includes at least one of: (a) reducing the thickness of a continuous sheet of polymer material; (b) reducing and mitigating manufacturing defects typically found in a commercially available pre-formed polymeric film; and (c) enabling the use of high quality, high temperature resistant, and high capacitance material in thin film capacitors.

Exemplary embodiments of bi-axially stretched polymeric thin films and related methods of formation are described above in detail. The films and methods are not limited to the specific embodiments described herein, but rather, components of systems and/or steps of the methods may be utilized independently and separately from other components and/or steps described herein. For example, the configuration of components described herein may also be used in combination with other processes, and is not limited to practice with only dielectric films and related methods as described herein. Rather, the exemplary embodiment can be implemented and utilized in connection with many applications where forming a stretched film is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A stretched dielectric film comprising a sheet fabricated from a dielectric material, said sheet having a thickness of less than about 5 microns, wherein said dielectric material comprises an amorphous polymer, and wherein said dielectric material is substantially free of a solvent.

2. The dielectric film in accordance with claim 1, wherein said dielectric material has a solvent content of less than about 30 parts per million (ppm) by weight.

3. The dielectric film in accordance with claim 1, wherein said dielectric material has a metal content of less than about 50 ppm by weight.

4. The dielectric film in accordance with claim 1, wherein said dielectric material is substantially free of a slip agent.

5. The dielectric film in accordance with claim 1, wherein said amorphous polymer has a glass transition temperature greater than about 140° C.

6. The dielectric film in accordance with claim 1, wherein said amorphous polymer comprises at least one of a polyetherimide, a polycarbonate, a polysulfone, a polyethersulfone, a polyamide-imide, and combinations thereof.

7. The dielectric film in accordance with claim 1, wherein said sheet is substantially free of surface defects comprising at least one of pin-holes, tin-canning, and wrinkling.

8. The dielectric film in accordance with claim 7, wherein said sheet has a surface area, and wherein at least about 80 percent of the surface area is free of the surface defects.

9. The dielectric film in accordance with claim 1, wherein said sheet has an average surface roughness of less than about 3 percent of an average film thickness.

10. The dielectric film in accordance with claim 1, wherein said sheet has a thickness variation of less than about 10 percent.

11. A film capacitor comprising:
at least one layer of metallic material; and
a dielectric film coupled to said at least one layer of metallic material, said dielectric film comprising a sheet fabricated from a dielectric material, said sheet having a thickness of less than about 5 microns, wherein said dielectric material comprises an amorphous polymer, and wherein said dielectric material is substantially free of a solvent.

12. The film capacitor in accordance with claim 11, wherein said dielectric material has a solvent content of less than about 30 parts per million (ppm) by weight.

13. The film capacitor in accordance with claim 11, wherein said dielectric material has a metal content of less than about 50 ppm by weight.

14. The film capacitor in accordance with claim 11, wherein said dielectric material is substantially free of a slip agent.

15. The film capacitor in accordance with claim 11, wherein said amorphous polymer has a glass transition temperature greater than about 140° C.

16. The film capacitor in accordance with claim 11, wherein said amorphous polymer comprises at least one of a polyetherimide, a polycarbonate, a polysulfone, a polyethersulfone, a polyamide-imide, and combinations thereof.

17. The film capacitor in accordance with claim 11, wherein said sheet is substantially free of surface defects comprising at least one of pin-holes, tin-canning, and wrinkling.

18. The film capacitor in accordance with claim 17, wherein said sheet has a surface area, and wherein at least about 80 percent of the surface area is free of the surface defects.

19. The film capacitor in accordance with claim 11, wherein said sheet has an average surface roughness of less than about 3 percent of an average film thickness.

20. The dielectric film in accordance with claim 11, wherein said sheet has a thickness variation of less than about 10 percent.
